(19) United States
(12) Patent Application Publication
(10) Pub. No.: US 2021/0396077 A1
(43) Pub. Date: Dec. 23, 2021

(54) SAFETY LADDER

(71) Applicant: Deltroninc Innovations LLC, Mt. Clemens, MI (US)

(72) Inventor: Lawrence Darrell Rogalski, Mt. Clemens, MI (US)

(21) Appl. No.: 17/350,831

(22) Filed: Jun. 17, 2021

Related U.S. Application Data
(60) Provisional application No. 63/040,113, filed on Jun. 17, 2020.
(60) Provisional application No. 63/126,027, filed on Dec. 16, 2020.

(51) Int. Cl. E06C 1/22; E06C 7/14; E06C 7/44; E06C 7/42

(52) U.S. Cl. CPC E06C 1/22; E06C 7/423; E06C 7/44; E06C 7/14

(57) ABSTRACT

A ladder is disclosed having a six point base for improved stability and user center of gravity.

### CROSS REFERENCE TO RELATED APPLICATIONS

This application claims the benefit of the filing dates of both U.S. Provisional Patent Application 63/040,113 filed Jun. 17, 2020 which is incorporated herein in its entirety and U.S. Provisional Patent Application 63/126,027 filed Dec. 16, 2020 which is incorporated herein in its entirety.

### TECHNICAL FIELD

In one aspect, the disclosure relates to the structural design of a safety ladder and means for accomplishing the use of said safety ladder. Ladders, such as step ladders, are often comprised of two parallel rails with steps extending transversely therebetween. The parallel rails are pivotally attached to a platform at a first end. On an opposite second end, the parallel rails act as legs and contact the ground during use or storage. Conventional step ladders further include pivotally attach second parallel rail structures with a cross bar extending between the second set of parallel rails to provide a support against transverse movement of the ladder while in use. However, conventional ladders, such as step ladders, are not entirely suitable for use on uneven terrain or in inclined situations. The parallel rails, which act as legs at their second end opposite said first end, are not adjustable to accommodate the uneven terrain upon which they are placed. Accordingly, the user may experience uncertainty when using a conventional ladder under such circumstances.

Tang, U.S. Pat. No. 10,378,278 discloses a smart ladder system which may be A-frame types of ladders, such as A-frame ladders and A-frame platform ladders. The ladder includes right and left stabilizer leg units which are swiveled coupled to the right and left rails of the ladder to provide support. The stabilizers may be swiveled relative to the rails of the ladder but are always positioned to the outside of the rail.

There is a need for a ladder that includes an improved foundational base to overcome dissimilar and similar terrains while operating a ladder so that users may enjoy increased structural security and improved user center of gravity while elevated during the operation of the safety ladder on uneven planes of ground; and the ladder will not tip over at lower elevations of ground and varying user orientation.

Such a ladder may be designed to set and fix a safety apparatus precisely at a desired spot with improved safety and stability and to be repositioned at another favorable position with the same safety and stability on uneven and even terrains. It is one advantage to achieve precise setting of stabilizer extending support poles and fixing on terrains while using the safety apparatus; otherwise it may produce decreased or no improved safety for the user of a ladder. Another purpose is for the article to provide a foundational base design that yields satisfactory results to the user, which will facilitate a balanced center of gravity in the user when elevated yielding further improved stability and safety. Briefly, the stabilizers are constructed to be telescoping, whereby a first member has a greater diameter along its length than a second member so that the second member slidably fits within the length of the first member. Apertures may be positioned along varying lengths of the stabilizer extending support poles. The apertures interact with latches or attachment mechanisms such that when the stabilizer poles are extended to their desired position, they are locked into place by the latch or attachment mechanism. In this way, each stabilizer pole may be extended at different lengths in either one or both of the stabilizer extending support poles. Each side of the safety apparatus contains a geometric pattern including at least two-sided ninety-degree angles similar to a gable which carries a desired design. In view of this factor, and the fact that only common and inexpensive materials and simple manufacturing procedures are required, the invention has a high commercial value. In one embodiment, the disclosure relates to an improved frame mechanism for a ladder that serves to increase stability and safety of the ladder regardless of the terrain upon which the ladder is placed. The improved frame mechanism increases the surface area of the ladder base to provide greater stability as a user's center of gravity rises during the user's ascent of the ladder. To achieve this object, a first upper pair of two locking lift levers that operate on a swivel in a radius are disengaged at the top of the two stabilizer extending support poles. The stabilizer support poles are attached to the two upper locking hinge mechanisms inside the posterior facing top cap. Once disengaged, a second pair of two snap clamps attached to the two rail sides of the ladder on the lower inside of the front rails that is opposite the rear side rails. (See FIG. 4) When the lower two lift locking levers are unlocked, the two stabilizer extending support poles are elevated to release the stabilizer extending support poles from the two lower lift locking levers mounted on both sides of the ladder on the lower inside of the front rails that is opposite the rear side rails. The recessed stabilizer support poles may be oriented to the interior of the apparatus rails and may extend until the second pair of lift locking levers are engaged. The stabilizer extending support poles are positioned at a desired angle from the apparatus and can be flush to the terrain with support bases to increase user stability at the end of said extending support poles. When the location of the apparatus needs to be changed, the apparatus, now with improved center of gravity arising from the stabilizer ladder foundation base design of six points of stability, overcomes dissimilar and similar terrains with repositioning of the stabilizer extending support poles or the recessed stabilizer ladder spreaders. In doing so, the user of the apparatus is also allowed increased individual safety and greater stability in their center of gravity when at different elevations on the steps of the apparatus. The ladder apparatus also has a guardrail with handle grips on each side of the guardrail which can be adjusted in height for user satisfaction by engaging pressure button lock mechanisms on both sides of said handle grips. The guardrail is attached to the top cap of the ladder. The ladder may also have a tool deck with openings and a magnetic recess pan to store user tools while using the ladder.

### SUMMARY

In one embodiment, there is disclosed a ladder with improved safety features. The safety feature may be a pair of extendible stabilizer supports or poles. The stabilizer poles may be constructed of a first member having opposed first and second ends with a length extending therebetween. The first member may have any cross sectional configuration or shape (i.e., polygonal, ovoid or circular) with a first cross sectional circumference (in the case of an ovoid or circular cross section) or a first cross sectional perimeter (in the case of a polygonal cross sectional area). The first member may be further equipped at its first end with (or attached to) a swivel joint that in turn is attached to the underside of a top cap of a step ladder. The stabilizer poles further include a second member with opposed first and second ends separated by a length that has a second member cross sectional configuration. The second member cross sectional configuration may be different (smaller or greater) than the first member cross sectional configuration. Either (or both) of the first or second member may be hollow so that the second member may be slidably moved or positioned along the length of the first member. A locking mechanism may be positioned along the length of the first or second member such that the position of the first or second member may be fixed in place relative to the length of the other member. The locking mechanism may be a latch to engage at least one of a series of apertures along the length of the first or second members. A torsion latch mechanism may also be used to secure the position of the second member relative to the length of the first member. The second end of the second member may further be equipped with a foot support or base. The support or base may be configured to have a gripping surface to interact with the surface of the terrain upon which it is placed to provide greater stability to the ladder when the stabilizer pole is in an extended position. In another embodiment, the ladder may be equipped with an extendible guardrail with handles. In yet another embodiment, the ladder may be equipped with an extendible guardrail with handles and a tool deck with receptacle to hold various tools as a user may desire.

### BRIEF DESCRIPTION OF THE DRAWINGS

FIG. 1 is a detail side view of a ladder depicting the stabilizer support poles;

FIG. 2 is a detail front view of the ladder of FIG. 1 depicting the posterior facing top cap of a safety ladder, the upper locking hinge mechanism that operates on a swivel in a radius, and the stabilizer support pole;

FIG. 3 is a detail front view of the ladder of FIG. 1 depicting the posterior facing top cap, showing the upper locking hinge mechanism that operate on a swivel in a radius;

FIG. 4 is a detail front view of the latter of FIG. 1 showing the tension spring clamp on the ladder rail securing the stabilizer pole in place;

FIG. 5 is a detailed perspective front view showing the stabilizer support pole, and the base support on said the stabilizer support pole;

FIG. 6 is a detail side view showing the stabilizer support pole, and the f base support on said the stabilizer support pole;

FIG. 7 is a detail side view of the ladder of FIG. 1 with the configured ladder safety latches to accommodate the stabilizer spreaders;

FIG. 8 is a back view of the ladder of FIG. 1 in an operational position showing the stabilizer support poles fully extended, the stabilizer support pole lever with foot pads extended at an acute angle relative from the top cap;

FIG. 9 is a side view of the ladder of FIG. 1 in a closed and storage position;

FIG. 10 is a schematic top view of the guardrail with handles and pressure button lock mechanisms fixed atop the top cap of said safety ladder, and a tool deck on top of said guardrail;

FIG. 11 is a schematic view of the guardrail with handles and pressure button lock mechanisms fixed atop the top cap of said safety ladder with an upper locking lever, and a tool deck on top of said guardrail;

FIG. 12 is a schematic view of the guardrail with handles and pressure button lock mechanisms fixed atop the top cap of said safety ladder with an upper locking lever, and a tool deck on top of said guardrail.

FIG. 13 is a cross-sectional view illustration depicting a ladder rail leg with a grip and lock control disengaging a locking grooved extension leg releasing a padded foot to be engaged by a locking seam.

### DETAILED DESCRIPTION

Referring now to the discussion that follows and also to the drawings, illustrative approaches to the disclosed systems and methods are described in detail. Although the drawings represent some possible approaches, they are not exhaustive of the modifications possible and the drawings are not necessarily to scale and certain features may be exaggerated, removed, sectioned out-of-plane, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

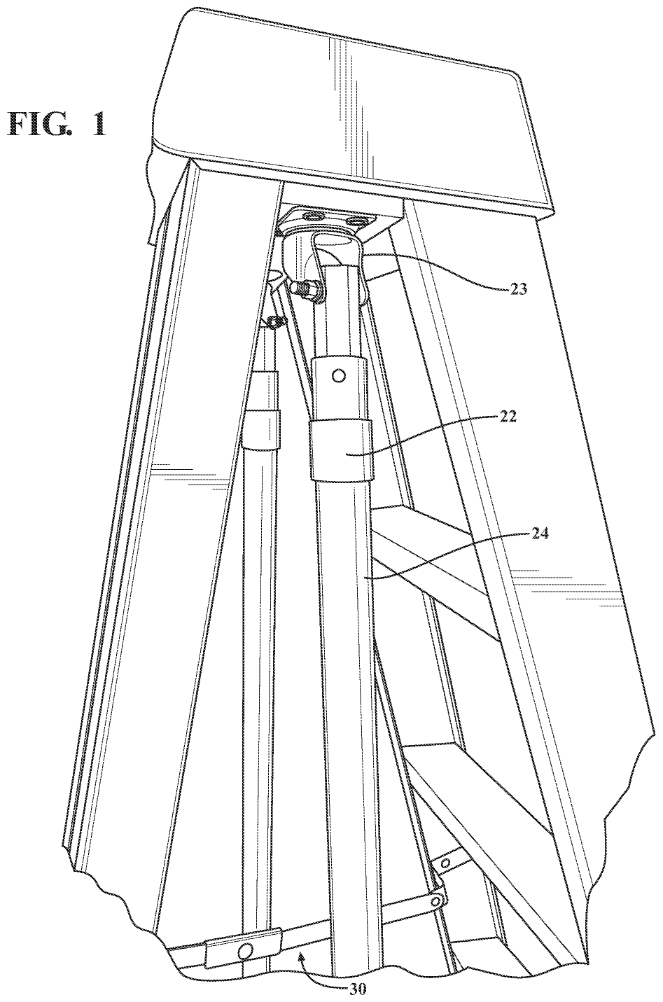

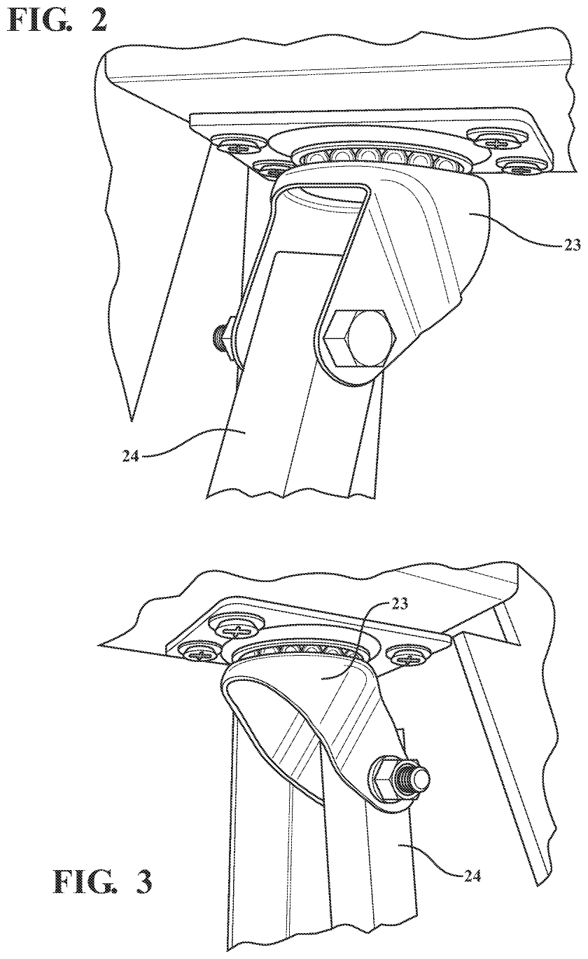

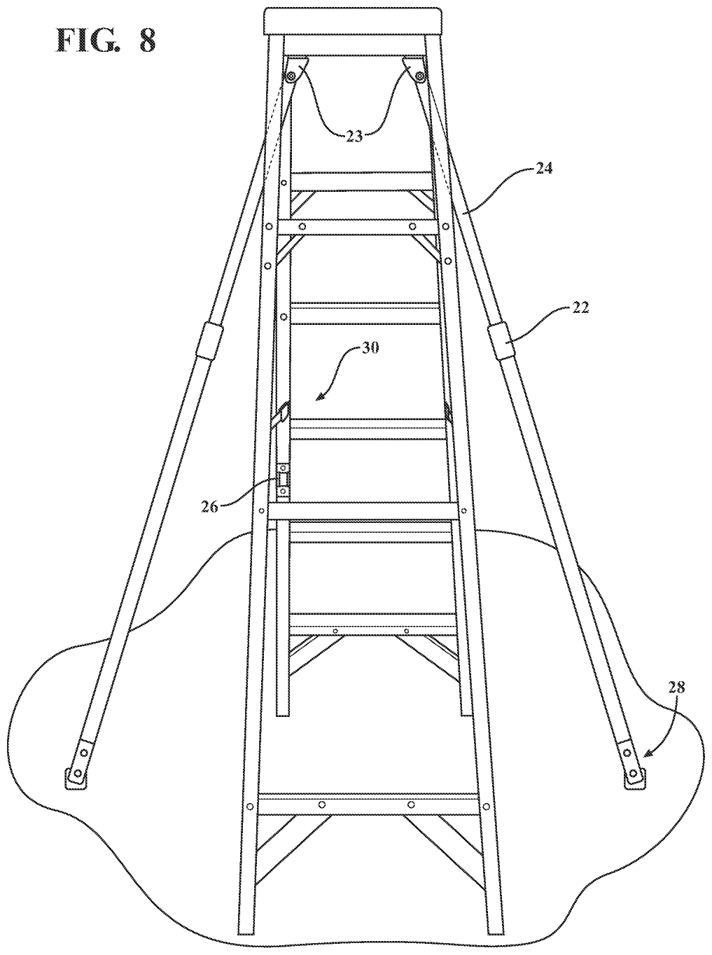

With reference to FIG. 1-8, the first pair of locking lift levers 22 are attached to the locking hinge mechanisms 23 that operates on a swivel in a radius. The locking hinge mechanism is attached to the underside or posterior face of the ladder top cap. In this embodiment, the locking lift lever 22 is attached to a first end 19 of the second member 25 of the stabilizer support poles 24 (See FIG. 8). When the locking lift levers are disengaged, the second member is slidably movable relative to the first member 27 to extend the stabilizer poles to their desired length. With continued reference to FIG. 8, the extended stabilizer poles 24 show the first member 17 with a first end 13 attached to the swivel joint separated from a second end 11 by a length 15. The first member and the second member have a cross sectional configuration 21 that may be any shape such as ovoid, circular, or polygonal. In this embodiment, the first member is slidably moveable or positional relative to the second member, but it is equally contemplated that the reverse is also possible. In order for the members to be moveable relative to each other, it is contemplated the either or both members may be hollow and one of the members has a cross sectional area that is larger than the other to accomplish the telescoping or slidable movement of one member relative to the other. The upper locking hinge mechanisms may use torsion clamps or tension clamping actions, or there may be a series of apertures in one of the first or second member such that a latch engages the aperture to hold the first and second member in place relative to each other.

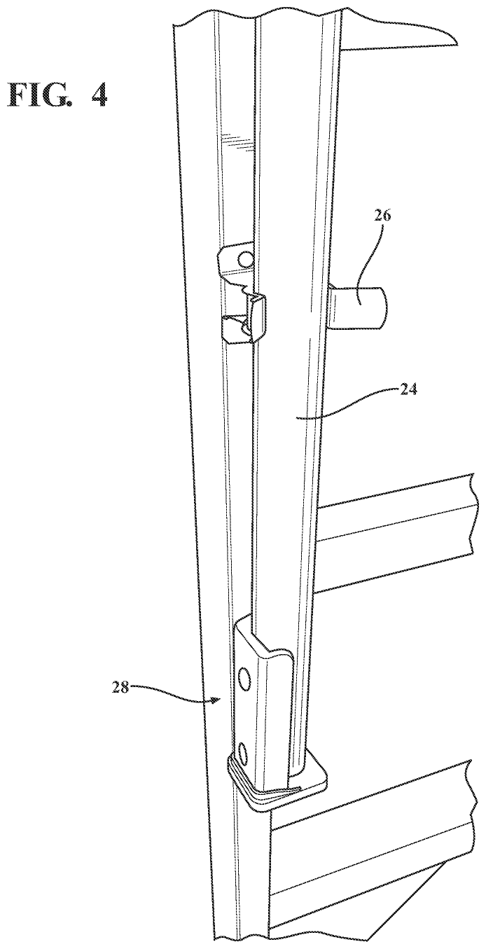

With reference to FIG. 4, a snap clamp 26 is attached to the front rail of the safety ladder and snap locks the extendible stabilizer support poles 24 in place to the front rail of said safety ladder. The snap clamp is useful for storage or controlling unwanted movement of the stabilizer poles on the ladder

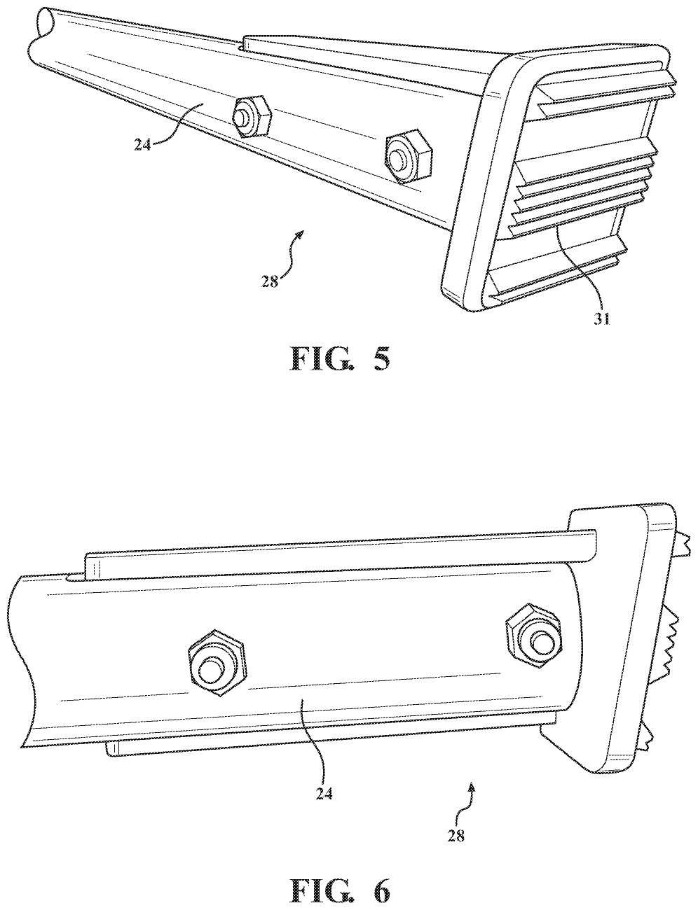

With reference to FIG. 5-6, the second member of the stabilizer pole is equipped with a base 28 which is affixed to the second end of the second member of the extendible stabilizer support pole 24 by way of bolts or other fasteners. The base may be configured with a gripping surface 31 so that users may enjoy increased grip and stability on various terrains.

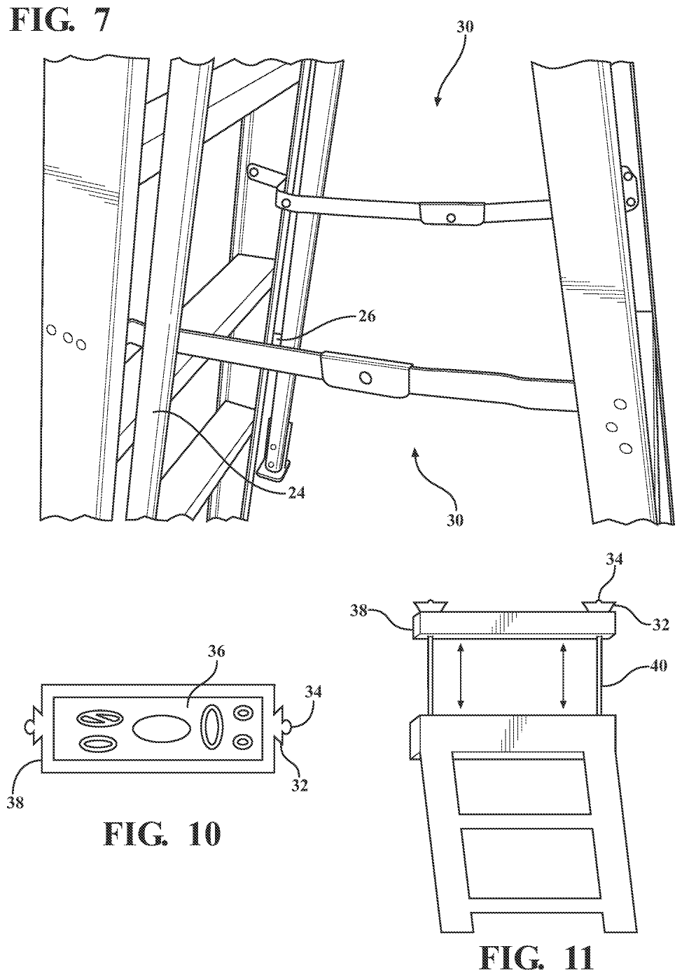

With reference to FIG. 7, the ladder spreaders 30 are configured to fully extend while the stabilizer support poles 24 are locked to the front rails of said safety ladder by the lower locking lift levers 26 attached to said front rails. The ladder spreaders are bent as their first end to accommodate the stabilizers when they are held in place by the snap clamps.

Returning to FIG. 8, poles 24 are in an extended position with support bases 28 shown flush to the terrain, whereby out-ward facing bolts mounted to the interior of the stabilizer safety ladder rails attach the four rails of the safety ladder to the recessed stabilizer safety ladder spreaders 30. The stabilizer safety ladder spreaders 30, while extended, engage the stabilizer safety ladder foundation base, and the attached to the four legs of the stabilizer safety ladder. The stabilizer extending support poles 24 fully extend at an acute angle relative to the ladder top and the base 28 of each stabilizer pole is flush to the terrain. As will be readily understood, the improved ladder as seen in FIG. 8 has a base with 6 points of contact. Those six (6) points of base contact include the four (4) base contact points formed by the ladder rails contacting the terrain, and the 2 base contact points formed by the contact of the stabilizer support poles to the terrain.

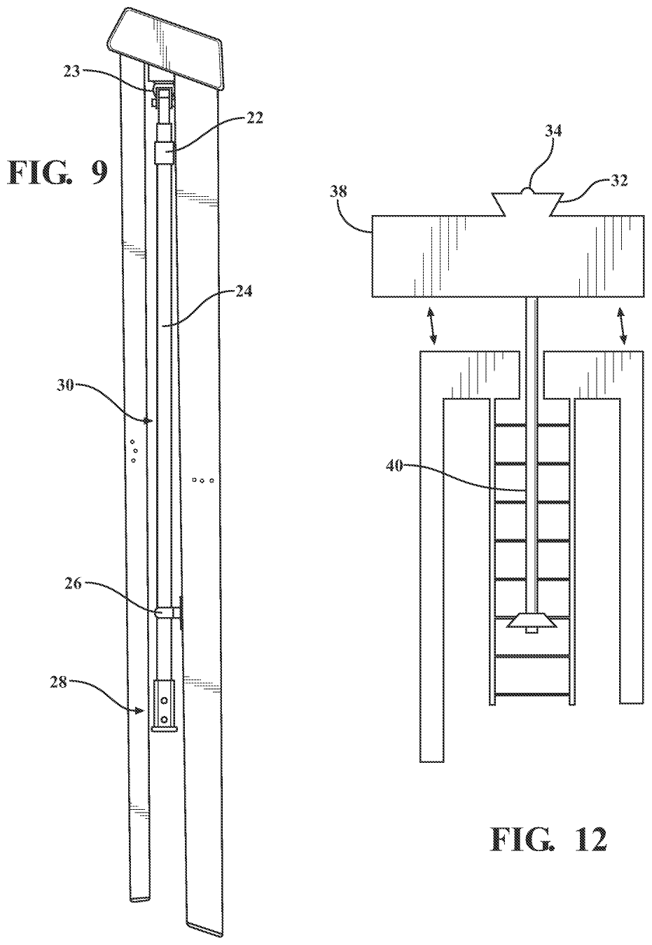

With reference to FIG. 9, the ladder is shown in a closed position. The configured spreaders 30 are folded at a pivot point to permit the ladder to close and thereby allow the four rails of the ladder to come together. The upper locking hinge mechanisms are operated to disengage the stabilizer support poles 24 and permit the telescoping movement of the first and second members relative to each other. It is then contemplated to secure the stabilizer poles in snap clamps 26 to hold them relative to the ladder rails and prevent unwanted movement of the stabilizer poles.

With reference to FIG. 10, the guardrail 38 with a tool deck 36 is mounted to the top cap of the ladder whereby the pressure button lock mechanisms 34 attached to handle grips 32 allow for adjustment of the guardrail 38 with a tool deck 36 relative to the top cap.

With reference to FIGS. 11-12, the guardrail 38 with a tool deck 36 is mounted to the top cap of the ladder whereby the pressure button lock mechanisms 34 attached to handle grips 32 allow for adjustment in height of the guardrail 38 with a tool deck 36 by the upper locking lever 40.

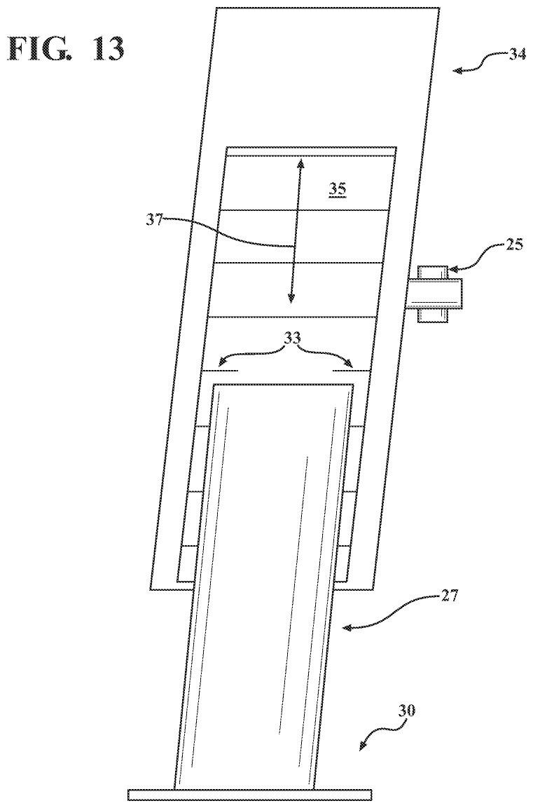

With reference to FIG. 13, the grip and lock control 25 disengages the locking grooved leg 27 which allows foot 30 to be flush to dissimilar terrain. The locking grooved leg is adjustably moveable along direction 37 within groove 35 in the ladder leg and may become engaged by the locking seam 33 attached to the ladder rail leg.

Those skilled in the art will recognize that the terms in this specification are words of description and not of limitation. Many variations and modifications are visible without departing from the scope and spirit of the invention.

What is claimed as new and desired to be protected in Letters of Patent of the United States is:

1. A ladder having a six point base for improved stability and user center of gravity, comprising:
at least four opposed rails pivotally attached at a first end to an underside of a top cap; two of said rails forming a first rail unit and a two of said rails forming a second rail unit; said first rail unit rails extending parallel to each other and said second rail unit rails extending parallel to each other; said first rail unit having at least one step extending transversely therebetween; said rails together forming a four point ladder base support at a second end;
said ladder further equipped with at least two stabilizer support poles forming additional two points of ladder base support; said stabilizer support poles including a first member with opposed first and second ends separated by a length, said first member having a first cross sectional configuration; said first member attached at said first end to a first lever locking hinge mechanism that operates on a swivel located on said underside of said top cap; said stabilizer pole further including a second member having a first and second end separated by a length and having a cross sectional configuration adapted for telescoping or slidable movement with said first member; said second member equipped with a locking lift lever at its first end; said first member attached to said to said first lever locking hinge mechanism that operates on a swivel located on said underside of said top cap; said second member of said stabilizer support pole equipped with a support base at its second end; said rails having at least one snap clamp for clamping said stabilizer extending support poles;
the top cap further equipped with an upper surface having a guardrail; said guardrail having at least one handle; said handle having at least one pressure lock mechanism; said guardrail further equipped with a tool deck.

2. The ladder of claim 1, wherein said second rail unit is equipped with a cross member extending between the rails of the second rail unit.

3. The ladder of claim 1, wherein the swivel comprise bearing housings to accommodate and freely rotate the stabilizer units about a vertical axis that is perpendicular to the ground.

4. The ladder of claim 1, wherein said tool deck is attached to retractable extending legs; said extending legs insertable through said top cap and into one of said first and second rail unit; said tool deck equipped with a pressure lock button to engage and disengage the legs of the tool deck.

5. The ladder of claim 1, wherein said tool deck is configured with preformed apertures or indentations adaptable to accept tools therein.

6. The ladder of claim 4, wherein said tool deck is equipped with a locking mechanism to secure the tool deck in place when the retractable legs are extended.

7. The ladder of claim 1, further including a groove with locking seams in each rail of sail first rail set; and a locking grooved leg adjustably positioned within said groove, said ladder further including a lock control to disengage said grooved locking leg.
